(19) United States
(12) Patent Application Publication
(10) Pub. No.: US 2013/0180071 A1
(43) Pub. Date: Jul. 18, 2013

(54) WIPER BLADE FOR A WINDSHIELD WIPER

(71) Applicants: Johan Camps, Glabbeek (BE); Jan Van Hoye, Tessenderlo (BE); Andreas Huehsam, Heverlee (BE); Jochen Weidlich, Rastatt (DE)

(72) Inventors: Johan Camps, Glabbeek (BE); Jan Van Hoye, Tessenderlo (BE); Andreas Huehsam, Heverlee (BE); Jochen Weidlich, Rastatt (DE)

(73) Assignee: ROBERT BOSCH GMBH, Stuttgart (DE)

(21) Appl. No.: 13/698,821

(22) PCT Filed: Apr. 18, 2011
(86) PCT No.: PCT/EP11/56089

§ 371 Date: Apr. 1, 2013

(30) Foreign Application Priority Data
May 19, 2010 (DE) 10 2010 029 107.2

(51) Int. Cl. B60S 1/40

(52) U.S. Cl. CPC B60S 1/40
USPC 15/250.32; 29/428

(57) ABSTRACT

In a wiper blade for a windshield wiper, having a wiper strip which has at least one bearing rail (212), onto which a basic connecting device (116) formed of plastic is integrally molded and is fixed to an adapter unit for attaching the wiper strip to a wiper arm, the at least one bearing rail (212) has a spring element (313) provided with a plastic sheath (213), wherein a fused connection (512, 514) is formed between the basic connecting device (160) and the plastic sheath (213), at least in some sections.

### BACKGROUND OF THE INVENTION

The present invention relates to a wiper blade for a windshield wiper, having a wiper strip which has at least one support rail, onto which a basic connecting device which is constructed from plastic is integrally molded, and which is attached to an adapter unit for coupling the wiper strip to a wiper arm.

EP 1 053 144 B1 describes such a wiper blade in which a basic connecting device which is constructed from plastic is integrally molded onto a metallic support rail. In this context, the metallic support rail is inserted into an assigned injection mold or casting mold into which heated, curable plastic is introduced, which plastic forms the basic connecting device when it cools and cures.

The disadvantage with this prior art is that the connection of the metallic support rail to the basic connecting device which is constructed from plastic is problematic when comparatively large shearing forces occur in a direction along the support rail during operation of the wiper blade and in the event of relatively large temperature fluctuations.

### SUMMARY OF THE INVENTION

An object of the invention is therefore to make available a new wiper blade for a windshield wiper in which stable and secure attachment of a basic connecting device to a support rail is brought about.

This problem is solved by means of a wiper blade for a windshield wiper, having a wiper strip which has at least one support rail, onto which a basic connecting device which is constructed from plastic is integrally molded, and which is attached to an adapter unit for coupling the wiper strip to a wiper arm. The at least one support rail has a spring element which is provided with a plastic sheath. A fused connection is constructed, at least in certain sections, between the basic connecting device and the plastic sheath.

The invention therefore permits simple and reliable attachment of the basic connecting device to the support rail of the wiper blade.

The fused connection is preferably constructed by fusing the plastic of the basic connecting device to the plastic sheath of the at least one support rail when the basic connecting device is integrally molded on.

It is therefore possible, by welding the basic connection device to the plastic sheath of the support rail, to bring about improved transmission of force from an assigned wiper arm to the wiper strip or a wiper lip, assigned to the wiper blade, when there is a comparatively small variation in pulling off forces.

The basic connecting device is preferably constructed from a curable plastic which is integrally molded onto the at least one support rail by plastic injection molding. The curable plastic is preferably designed to permit local fusing on of the plastic sheath during the plastic injection molding, in order to bring about the fused connection.

It is therefore easily possible to bring about stable welding of the basic connecting device to the plastic sheath of the support rail.

The basic connecting device preferably has a base body on which the lateral securing elements are provided, which securing elements engage, at least in certain sections, around the at least one support rail in a claw-like manner.

It is therefore possible to construct a secure and reliable basic connecting device.

The adapter unit preferably has plastic and is designed to connect to a connecting element which is assigned to the wiper arm.

The wiper strip can therefore be easily connected to the wiper arm.

According to one embodiment, the adapter unit is welded onto the basic connecting device.

The invention therefore permits stable and reliable attachment of the adapter unit to the basic connecting device.

The adapter unit is preferably welded onto the base body of the basic connecting device over a surface.

The adapter unit can therefore be welded to the basic connecting device with a comparatively large extent.

The problem mentioned at the beginning is also achieved by means of a method for manufacturing a wiper blade for a windshield wiper, wherein the wiper blade has a wiper strip on which at least one support rail, on which a basic connecting device which is constructed from plastic is integrally molded, is provided, which basic connecting device can be attached to an adapter unit for coupling the wiper strip to a wiper arm. The basic connecting device is integrally molded onto the at least one support rail by applying a curable plastic. The at least one support rail has a spring element which is provided with a plastic sheath. A fused connection is constructed, at least in certain sections, between the basic connecting device and the plastic sheath.

The invention therefore permits simple and reliable attachment of the basic connecting device to the support rail of the wiper blade. During the application of the curable plastic, the plastic sheath of the at least one support rail is preferably fused on, at least in certain sections, and connects to the curable plastic in order to construct the fused connection.

Secure and stable welding of the basic connecting device to the plastic sheath of the support rail can therefore be achieved.

The basic connecting device is preferably constructed with a base body and lateral securing elements provided thereon, wherein the lateral securing elements engage, at least in certain sections, around the at least one support rail in the manner of a claw, and at least one energy direction signal generator for welding to the adapter unit is constructed on the base body.

The invention therefore permits defined and controlled generation of fusion during the welding of the basic connecting device to the adapter unit.

### BRIEF DESCRIPTION OF THE DRAWINGS

The invention is explained in more detail in the following description, on the basis of exemplary embodiments illustrated in the drawings. In the drawings:

FIG. 1 shows a side view of a wiper blade having a wiper strip, onto which a basic connecting device is integrally molded, according to the one embodiment,

FIG. 2 shows a perspective view of a detail II of the wiper blade from FIG. 1, which detail II illustrates the support rails of the wiper blade from FIG. 1 after the integral molding on of the basic connecting device from FIG. 1,

FIG. 3 shows a sectional view of one of the support rails of the wiper blade from FIG. 1 which is inserted into an assigned injection mold or casting mold in order to integrally mold on the basic connecting device from FIG. 1,

FIG. 4 shows the sectional view from FIG. 3 after fixing of the injection mold or casting mold to the support rail,

FIG. 5 shows the sectional view from FIG. 4 during the construction of the basic connecting device, and

FIG. 6 shows the sectional view from FIG. 5 after the construction of the basic connecting device.

### DETAILED DESCRIPTION

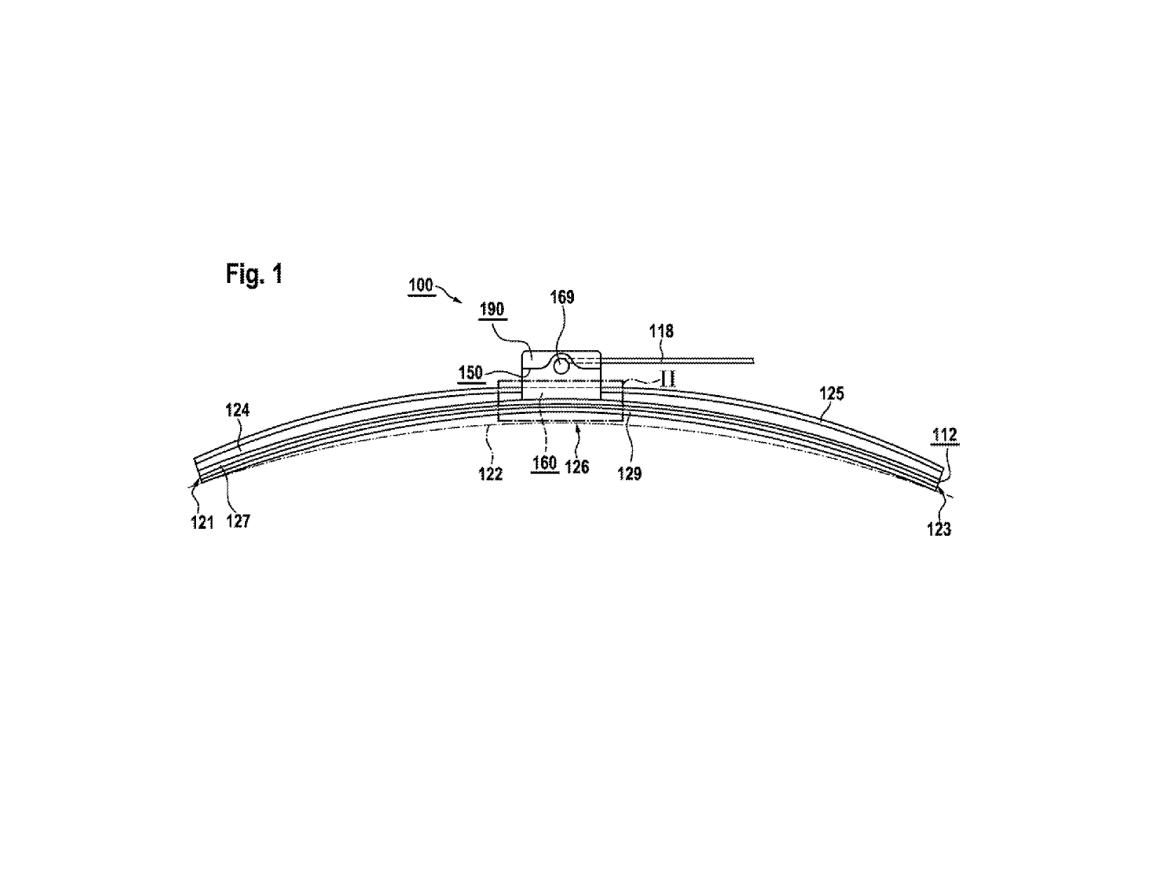

FIG. 1 shows a wiper blade 100 with a wiper strip 112 which has a wiper lip 129 which is connected to a back strip 124 via a tilting web 127. A spoiler 125 is provided on the back strip 124. A basic connecting device 160 is provided on the wiper strip 112, to which basic connecting device 160 an adapter unit 150 for connecting a connecting element 190 assigned to a wiper arm 118 is attached. The connecting element 190, also denoted as a securing spring, is connected in FIG. 1 to the adapter unit 150, also denoted here as a function adapter, for example via a joint bolt 169. By means of the wiper arm 118, the wiper blade 100 can be guided in order to wipe over a windshield 122, for example a motor vehicle windshield, which is represented by dot dashed lines.

However, it is to be noted that the embodiment of the wiper blade 100 with a basic connecting device 160 and adapter unit 150 for connecting the connecting element 190 is only of an exemplary character and is not to be understood as being a restriction of the invention. Instead alternative embodiments are also possible which are likewise within the scope of the present invention, for example the basic connecting device 160 and the adapter unit 150 can be embodied in one piece or the adapter unit 150 and the connecting element 190 can be embodied in one piece. Furthermore, the spoiler 125 is also optional, and the present invention can also be used in wiper blades without a spoiler.

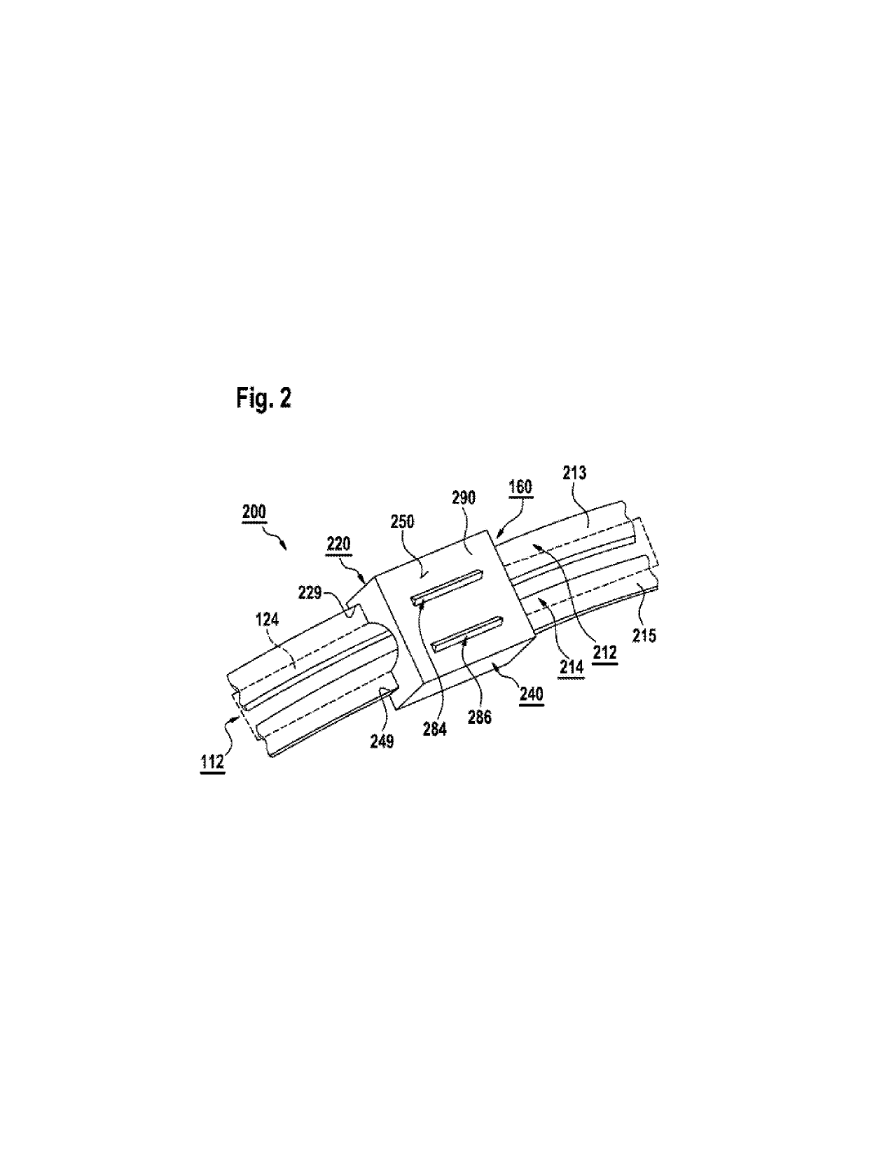

According to one embodiment, the wiper blade 100 is constructed with a flat bar design i.e. the wiper strip 112 has lateral longitudinal grooves in which two support rails (212, 214 in FIG. 2), are preferably spring rails, are arranged, as described by way of example below in the case of FIG. 2. In this context, the support rails (212, 214 in FIG. 2) can be connected to one another at their axial ends, for example by means of suitable end caps. As an alternative to this, the wiper strip 112 can be constructed as a hollow profile with an approximately central longitudinal duct in which an individual support rail is arranged. Such wiper blades and their embodiments are sufficiently known to a person skilled in the art, and therefore, in order to keep the description concise, a detailed description will not be given here.

The wiper strip 112 with the basic connecting device 160 provided thereon is preferably of joint-free design, wherein the basic connecting device 160 is preferably premounted on the wiper strip 112. According to one embodiment, the basic connecting device 160 is integrally molded onto the support rails (212, 214 in FIG. 2) by means of a suitable injection molding process or casting process and the adapter unit 150 is welded onto the basic connecting device 160, as described below in the case of FIGS. 2 to 6. For this purpose, the basic connecting device 160 and the adapter unit 150 have plastic and are preferably constructed as plastic parts.

In FIG. 1, the wiper blade 100 is not yet completely fitted onto the windshield 122, only its axial wiper blade ends 121, 123 resting on the windshield 122, while the wiper strip 112 is still spaced apart from the windshield 122 in the wiper blade center 126, i.e. approximately in the region of the adapter unit 150. If a pressing force which is provided is applied via the wiper arm 118 to the connecting element 190 and therefore to the adapter unit 150, the wiper strip 112 rests on the windshield 122, wherein a uniform pressure is brought about over the entire wiper blade length, even if the curvature of the windshield changes in the course of the wiping movement.

FIG. 2 is an illustrative view of an arrangement 200 of the basic connecting device 160 from FIG. 1, said basic connecting device 160 being integrally molded onto exemplary support rails 212, 214, provided with the plastic sheaths 213, 215, of the wiper blade 100 in FIG. 1. The support rails 212, 214 are arranged by way of example in assigned lateral longitudinal grooves of the wiper strip 112 of FIG. 1, said longitudinal grooves being formed, for example, on the back strip 124 of said wiper strip 112. The back strip 124 is indicated only schematically for the sake of clarity and overview of the drawing in FIG. 2, while the other wiper strip components have not been shown in order to simplify the illustration.

According to one embodiment, the basic connecting device 160 has a base body 290 on which lateral securing elements 220, 240 are provided. The lateral securing element 220 extends in an approximate L shape starting from the base body 290 and forms therewith a groove 229. The lateral securing element 240 extends, relative to the securing element 220, in an approximately horizontally mirrored L shape starting from the base body 290, and forms therewith a groove 249. The basic connecting device 160 is arranged illustratively on the wiper strip 112 in such a way that the securing elements 220, 240 engage, at least in certain sections, around the support rails 212 and 214, respectively, in the manner of a claw. In this context, the support rail 212 is arranged by way of example in the groove 229 and the support rail 214 is arranged in the groove 249 of the basic connecting device 160.

Two optional, illustratively elongate energy direction signal generators 284, 286 are provided on an upper side 250 of the base body 290, which energy direction signal generators 284, 286 can be used in the case of welding of the basic connecting device 160 to the adapter unit 150 in FIG. 1, in order to permit defined and controlled generation of fusion during the welding of the basic connecting device 160 to the adapter unit 150. As a result, it is possible, for example by means of ultrasonic welding, to form a planar welding seam between the basic connecting device 160 and the adapter unit 150, which welding seam has preferably approximately the dimensions of the upper side 250 of the base body 290.

However, it is to be noted that the description of a welded connection between the basic connecting device 160 and the adapter unit 150 in FIG. 1 is only of an exemplary character and is not to be understood as being a restriction of the invention. Instead, the adapter unit 150 can be attached to the basic connecting device 160 in any desired fashion, for example by latching, bonding, riveting or screwing. In these cases, it is also possible to construct the adapter unit 150 substantially without plastic, for example in a metallic fashion.

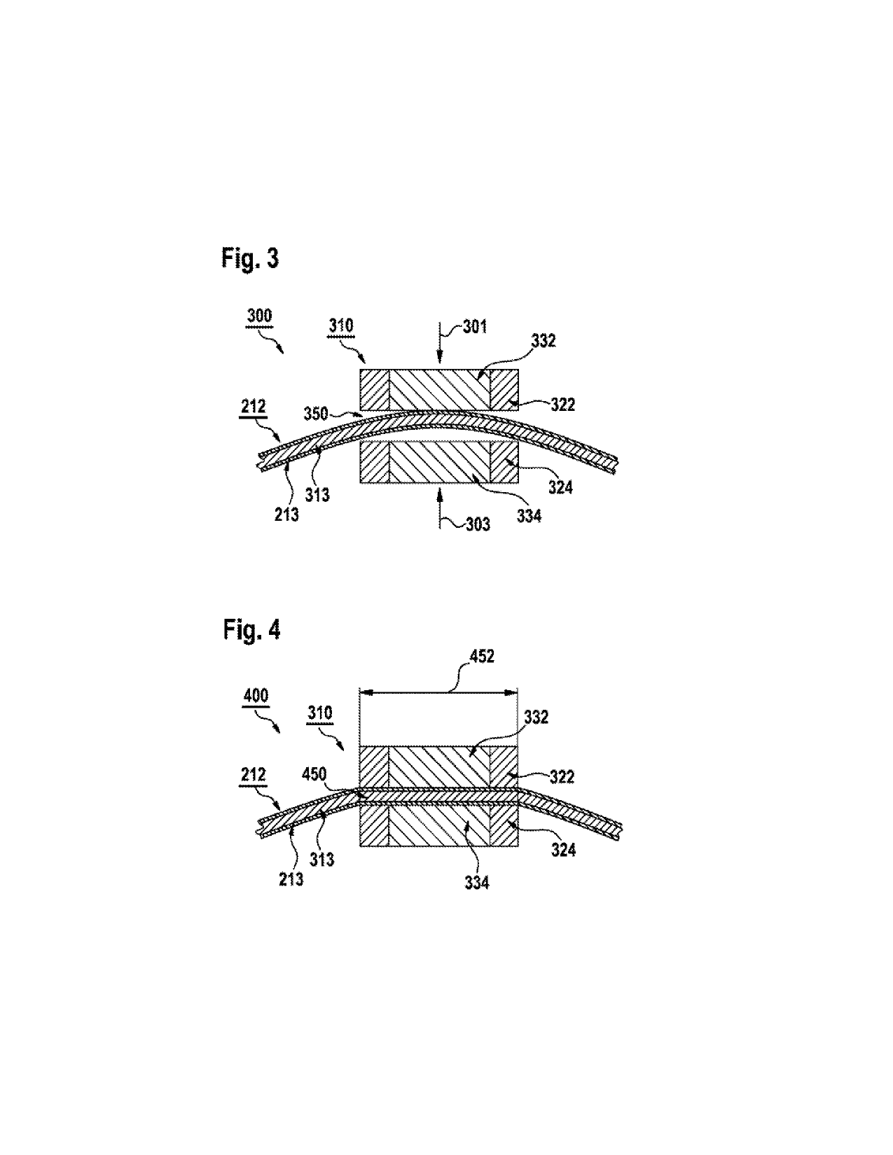

FIGS. 3 to 6 show sectional views illustrating a method for manufacturing the arrangement 200 in FIG. 2. In order to simplify the illustration, FIGS. 3 to 6 merely show an axial, substantially central section of the support rail 212 in FIG. 2, while the other wiper strip components have not been illustrated for the sake of clarity and overview of the drawing. However, it is to be noted that what is shown in FIGS. 3 to 6 and described applies analogously to the support rail 214 in FIG. 2.

FIG. 3 shows an arrangement 300 with the support rail 212 from FIG. 2 and an illustratively open plastic injection mold or casting mold 310. According to one embodiment, the support rail 212 has a spring element 313 which is provided with the plastic sheath 213. Said spring element 313 is, for example, a spring rail which is formed from flat wire or round wire and is constructed, for example from hardened steel, titanium or aluminum. Alternatively, the spring element 313 can be constructed from plastic.

In order to integrally mold the basic connecting device 160 in FIG. 1 onto the support rail 212, in a first working step a predefined, for example central, region 350 of the support rail 212 is arranged in the open plastic injection mold or casting mold 310 which has a first mold section 322, at the top end in FIG. 3 and a second mold section 324 at the bottom end in FIG. 3. The upper mold section 322 is, for example, operatively connected to a first slider, at the top end in FIG. 3, or pin 332 with excessive rebound. Analogously to this, the lower mold section 324 is, for example, operatively connected to a second slider, the lower one in FIG. 3, or pin 334 with excessive rebound. In order to simplify the description, reference is made below only to the sliders 332 and 334, respectively. However, a person skilled in the art is sufficiently familiar with the functionality of suitable pins with excessive rebound as well.

However, it is to be noted that alternative refinements of the plastic injection mold or casting mold 310 are also possible within the scope of the present invention. For example, the mold 310 can be embodied without the sliders 332, 334, with the result that corresponding shaping of the basic connecting device 160 occurs directly by means of the upper and lower mold sections 322 and 324. As an alternative to this, an individual slider can be provided, with the result that the shaping occurs at least partially by means of the upper or lower mold sections 322 and 324, respectively.

According to one embodiment, the plastic injection mold or casting mold 310 is closed in a second working step. For this purpose, the upper mold section 322 is moved with the upper slider 332 in the direction of an arrow 301 toward the support rail 212, and the lower mold section 324 is moved with the lower slider 334 in the direction of an arrow 303 toward the support rail 212, for example by means of assigned core pullers. As an alternative to this, just one of the two mold sections 322, 324 can also be moved with the corresponding slider 332 or 334 in the direction of the other mold section.

FIG. 4 shows an arrangement 400 which illustrates the arrangement 300 in FIG. 3 with a closed plastic injection mold or casting mold 310. As is apparent from FIG. 4, according to one embodiment, the support rail 212 is curved by closing the plastic injection mold or casting mold 310 in a flattened or straight fashion in a predefined region 450 with a length 452 in the axial direction of the support rail 212. The length 452 corresponds here approximately to a longitudinal extent of the plastic injection mold or casting mold 310.

However, it is to be noted that during the closing of the plastic injection mold or casting mold 310 any desired shaping process is possible for the support rail 212, which shaping process can, for example, also provide partial flattening, or even no flattening, of the rail 212. This shaping process permits a substantially constant distribution of bearing force in the region of the basic connecting device 160, and can be reproduced precisely from one cycle to another by means of the plastic injection mold or plastic casting mold 310.

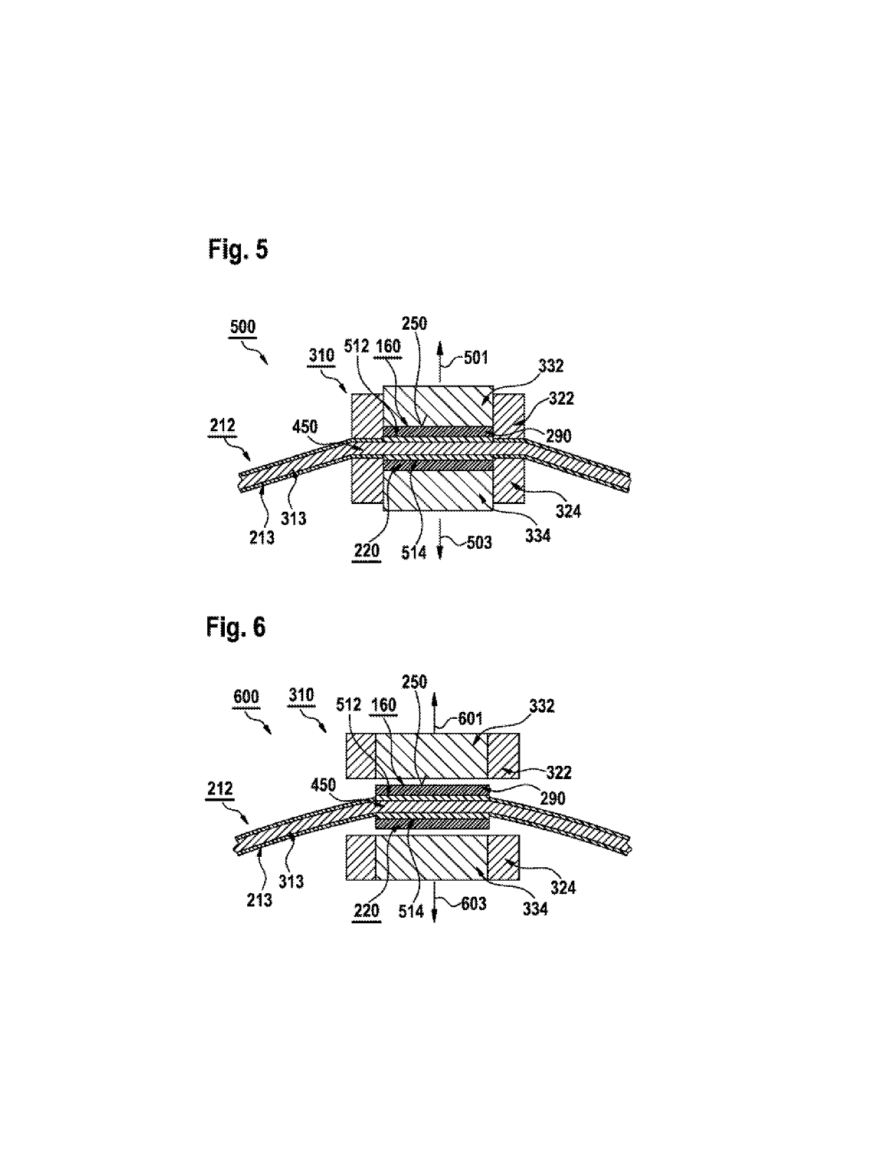

FIG. 5 shows an arrangement 500 which illustrates the arrangement 400 in FIG. 4. When a third working step is carried out in which heated, curable plastic is introduced into the plastic injection mold or casting mold 310. This curable plastic can, according to one embodiment, be injected into the plastic injection mold or casting mold 310 and in the process encapsulate the sliders 332, 334 through injection molding, wherein the support rail 212 is preferably embedded completely in the injected plastic and the basic connecting device 160 is, for example, partially constructed. A desired shaping process for the basic connecting device 160 which is to be constructed is generated here, for example, by assigned base surfaces or predefined contours of the sliders 332, 334. This is followed, for example, by curing of the injected plastic, with the result that the shaping process of the support rail 212 which is described in FIG. 4 is maintained by means of the hardened plastic. It is subsequently possible to pull away the sliders 332, 334, for example in the direction of arrows 501 and 503, respectively, by a predefined distance from the support rail 212, for example to move said sliders 332, 334 out by means of assigned core pullers. The pulling away of the sliders 332, 334 results in cavities in the plastic injection mold or casting mold 310 in the fully molded basic connecting device 160, which cavities can be filled by injection molding or casting with further curable plastic in the same working step or in a subsequent working step. In this context, a concluding shaping process or completion of the shaping process for the basic connecting device 160 can also occur.

In the illustrated exemplary embodiment, the sliders 332, 334 serve illustratively to construct the base body 290 of the basic connecting device 160 with the upper side 250, as well as the securing element 220 and the securing element 240 in FIG. 2. In this context, the plastic injection mold or casting mold 310 permits a comparatively high pressure to be maintained on the plastic which is introduced into the mold 310, thereby permitting this plastic to cure under high pressure. As a result, the curing of the plastic can be improved, wherein the spring rail 313 of the support rail 212 is secured in the form which is predefined according to FIG. 4.

According to one embodiment, the plastic which is introduced into the plastic injection mold or casting mold 310 brings about al least local fusing on of the plastic of the plastic sheath 213 of the support rail 212, for example in the region of the sliders 332, 334. As a result, the introduced plastic can bind to the fused-on plastic and thereby form a fused connection 512, 514 between the basic connecting device 160 and the plastic sheath 213. Since, as described above, this preferably occurs at a high pressure, this improves the final strength of the plastic or of the connection.

FIG. 6 shows an arrangement 600 which illustrates the arrangement 500 from FIG. 5 while the fourth working step is being carried out, during which, after cooling and curing of the plastic of the basic connecting device 160, the upper mold section 322 with the upper slider 332 in the direction of an arrow 601 and the lower mold section 324 with the lower slider 334 in the direction of an arrow 603 is moved away from the support rail 212. The support rail 212 with the basic connecting device 160 which is integrally molded thereon is then removed from the plastic injection mold or casting mold 310 in a concluding working step.

1. A wiper blade (100) for a windshield wiper, having a wiper strip (112) which has at least one support rail (212, 214), onto which support rail a basic connecting device (160), which is constructed from plastic, is integrally molded, and which basic connecting device is attached to an adapter unit (150) for coupling the wiper strip (112) to a wiper arm (118), characterized in that the at least one support rail (212, 214) has a spring element (313, 315) which is provided with a plastic sheath (213, 215), wherein a fused connection (512, 514) is constructed, at least in certain sections, between the basic connecting device (160) and the plastic sheath (213, 215).

2. The wiper blade as claimed in claim 1, characterized in that the fused connection (512, 514) is constructed by fusing the plastic of the basic connecting device (160) to the plastic sheath (213, 215) of the at least one support rail (212, 214) when the basic connecting device (160) is integrally molded on.

3. The wiper blade as claimed in claim 1, characterized in that the basic connecting device (160) is constructed from a curable plastic which is integrally molded onto the at least one support rail (212, 214) by plastic injection molding, wherein the curable plastic is designed to permit local fusing on of the plastic sheath (213, 215) during the plastic injection molding, in order to bring about the fused connection (512, 514).

4. The wiper blade as claimed in claim 1, characterized in that the basic connecting device (160) has a base body (290) on which lateral securing elements (220, 240) are provided, which securing elements (220, 240) engage, at least in certain sections, around the at least one support rail (212, 214) in a claw-like manner.

5. The wiper blade as claimed in claim 4, characterized in that the adapter unit (150) has plastic and is designed to connect to a connecting element (190) which is assigned to the wiper arm (118).

6. The wiper blade as claimed in claim 1, characterized in that the adapter unit (150) is welded onto the basic connecting device (160).

7. The wiper blade as claimed in claim 5, characterized in that the adapter unit (150) is welded onto a base body (290) of the basic connecting device (160) over a surface.

8. A method for manufacturing a wiper blade (100) for a windshield wiper, wherein the wiper blade (100) has a wiper strip (112) on which at least one support rail (212, 214), on which support rail a basic connecting device (160) which is constructed from plastic is integrally molded, is provided, which basic connecting device (160) can be attached to an adapter unit (150) for coupling the wiper strip (112) to a wiper arm (118), the method comprising integrally molding the basic connecting device (160) onto the at least one support rail (212, 214) by applying a curable plastic, wherein the at least one support rail (212, 214) has a spring element (313, 315) which is provided with a plastic sheath (213, 215), and constructing a fused connection (512, 514), at least in certain sections, between the basic connecting device (160) and the plastic sheath (213, 215).

9. The method as claimed in claim 8, characterized in that during the application of the curable plastic, the plastic sheath (213, 215) of the at least one support rail (212, 214) is fused on, at least in certain sections, and connects to the curable plastic in order to construct the fused connection (512, 514).

10. The method as claimed in claim 8, characterized in that the basic connecting device (160) is constructed with a base body (290) and lateral securing elements (220, 240) provided thereon, wherein the lateral securing elements (220, 240) engage, at least in certain sections, around the at least one support rail (212, 214) in the manner of a claw, and at least one energy direction signal generator (284, 286) for welding to the adapter unit (150) is constructed on the base body (290).
